(19) United States
(12) Patent Application Publication
(10) Pub. No.: US 2016/0041457 A1
(43) Pub. Date: Feb. 11, 2016

(54) PROJECTOR WITH WAVE LENGTH WHEEL AND COLOR WHEEL IN ONE MODULE

(71) Applicant: LG Electronics Inc., Seoul (KR)

(72) Inventors: Hong Lyeol OH, Seoul (KR); Young Jin KIM, Seoul (KR); Jun Park, Seoul (KR)

(73) Assignee: LG ELECTRONICS INC., Seoul (KR)

(21) Appl. No.: 14/818,018

(22) Filed: Aug. 4, 2015

(30) Foreign Application Priority Data
Aug. 11, 2014 (KR) 10-2014-0103237

(51) Int. Cl. G03B 21/20; G02B 26/00

(52) U.S. Cl. CPC G03B 21/204; G02B 26/008

(57) ABSTRACT

A projector with a wave length wheel and a color wheel in one module is proposed, the projector comprising: a light source configured to generate a first wavelength band light; a dichroic filter configured to reflect the first wavelength band light irradiated from the light source, and to transmit a second wavelength band light and a third wavelength band light; integrated wavelength conversion wheel and color wheel modules configured to integrally form a wave length wheel and a color wheel each wheel in a parallel manner in order to allow transmitting the first wavelength band light reflected from the dichroic filter and to generate the second wavelength band light and the third wavelength band light through wavelength conversion using the first wavelength band light as an excited light and to reflect the generated second wavelength band light and the third wavelength band light to the dichroic filter; and a light tunnel configured to receive the first wavelength band light reflected from the dichroic filter by transmitting the integrally formed wave length wheel and color wheel, and the second wavelength band light and the third wavelength band light transmit through the dichroic filter by being generated by and reflected from the integrally formed wave length wheel and color wheel.

Pursuant to 35 U.S.C. §119 (a), this application claims the benefit of earlier filing date and right of priority to Korean Patent Application No.10-2014-0103237, filed on Aug. 11, 2014, the contents of which are hereby incorporated by reference in their entirety.

### BACKGROUND OF THE DISCLOSURE

1. Field

The teachings in accordance with the exemplary embodiments of this present disclosure generally relate to a projector with a wave length wheel and a color wheel in one module configured to drive a wavelength conversion wheel and a color wheel using a single motor by manufacturing the wavelength conversion wheel and the color wheel on a single shaft in an integral parallel manner, each wheel discrete from another.

2. Background

Concomitant with fast development of information-oriented age, importance of display devices enabling to realize a large screen has been emphasized. An example of enabling to realize a large screen may be a projector having a function to transmit an image in an enlarged manner.

A projector is a projection device configured to display a large-sized image by enlarging a small image realized on a small-sized display formed therein, and transmitting the enlarged image on a large-sized screen using a penetration lens. The projector is largely divided into two types, that is, a front projection type in which an image is projected on a front surface of a screen, and a rear projection type in which an image is transmitted on a rear surface of a screen. A representative example of the rear projection type is a projection television. Furthermore, a liquid crystal projector advantageous in for miniaturization (small-size, thin-thickness) purpose of the projector is widely used as a display providing a small image in a projector.

A conventional liquid crystal projector may include a liquid crystal display device providing a small image, a projection lens system transmitting the realized small sized image on a screen, a light source providing a light source to the liquid crystal display device, an illumination system adjusting an optical path between the light source and the liquid crystal display device, and a driving circuit unit processing a signal. The liquid crystal projector can realize a high brightness through a high efficient optical system and lamp change. Furthermore, albeit being a bit less in brightness, the liquid crystal projector can emphasize portability and simplicity in installation through the miniaturization and lightness.

In order for the liquid crystal projector to realize various colors, the liquid crystal projector needs to control the primary colors of Red/Green/Blue (RGB). The liquid crystal projector may be largely classified into two types based on control method, that is, a single-panel type and a 3-panel type. The 3-panel type is generally used for realization of high brightness, while the single-panel type is used for the purposes of miniaturization and lightness of the device.

The 3-panel type is for a color-realization method using 3sheets, i.e., Red/Green/Blue (RGB) sheets of liquid crystal panels based on color separation and synthesis methods. The single-panel type can realize colors using color wheel, wavelength conversion wheel (phosphor wheel), a color switch, a hologram and a rotating prism. Among other things, the color wheel system type is widely used in consideration of mass production and efficiency.

Due to the fact that performance of projector is importantly considered, various new attempts are being waged recently in terms of software and hardware aspects. As an example, attempts to realize a projector using an LD (Laser Diode), an LED (Light Emitting Diode), an organic EL (OLED, Organic Electro Luminescence Display), and a fluorescent material or substance.

For example, when a voltage is applied across a laser diode, a laser beam having a predetermined wavelength can be emitted through stimulated emission and constructive interference. Laser beams respectively emitted from a plurality of laser diodes are collected through a lens to form a light source of high illuminance.

In general, a light source unit forms a light including various colors using a blue light. However, a separate blue light path is required in order to obtain the blue light, such that a space inside the light source unit is needed to form the blue light path.

### SUMMARY OF THE DISCLOSURE

The present disclosure is provided to solve the aforementioned disadvantages/problems and it is an object of the present disclosure to provide a projector with a wavelength conversion wheel and a color wheel in one module configured to drive a wavelength conversion wheel and a color wheel using a single motor by manufacturing the wave length wheel and the color wheel on a single shaft in an integral parallel manner, each wheel being discrete from another.

In one general aspect of the present disclosure, there is provided a projector with a wave length wheel and a color wheel in one module; the projector comprising:

a light source configured to generate a first wavelength band light;

a dichroic filter configured to reflect the first wavelength band light irradiated from the light source, and to transmit a second wavelength band light and a third wavelength band light;

an integrated wavelength conversion wheel and color wheel module configured to integrally form a wave length wheel and a color wheel each wheel in a parallel manner in order to allow transmitting the first wavelength band light reflected from the dichroic filter and to generate the second wavelength band light and the third wavelength band light through wavelength conversion using the first wavelength band light as an excited light and to reflect the generated second wavelength band light and the third wavelength band light to the dichroic filter; and a light tunnel configured to receive the first wavelength band light reflected from the dichroic filter by transmitting the integrally formed wave length wheel and color wheel, and the second wavelength band light and the third wavelength band light transmit through the dichroic filter by being generated by and reflected from the integrally formed wave length wheel and color wheel.

Preferably, but not necessarily, the integrated wavelength conversion wheel and color wheel module may include a shaft interacted with a motor at one side, and a wavelength conversion wheel unit and a color wheel unit, each center of which is assembled on the shaft, discrete at a predetermined distance and integrally assembled on the shaft, wherein the color wheel unit is installed toward the dichroic filter, and the wavelength conversion wheel unit is discretely installed from the color wheel unit to a direction opposite to the dichroic filter.

Preferably, but not necessarily, the wavelength conversion wheel unit may include a first area interacted with the color wheel unit to transmit a part of the first wavelength band light incident by transmitting the color wheel unit, and second and third areas respectively configured to generate the second wavelength band light and the third wavelength band light through wavelength conversion of phosphor using, as an excitation, another part of the wavelength band light incident by transmitting the color wheel unit, wherein each of the second and third areas is divided to a plurality of areas, each having a different wavelength conversion characteristic for each wavelength band, different light reflection and different light transmission characteristics.

Preferably, but not necessarily, the color wheel unit may include a first area interacted with the wavelength conversion wheel unit to transmit a part of the first wavelength band light incident from the dichroic filter to the wavelength conversion wheel unit, and second and third areas selectively transmitting the second wavelength band light and the third wavelength band light generated by the wavelength conversion wheel unit toward a dichroic filter side, wherein each of the second and third areas is divided to a plurality of areas, each having a different light reflection characteristic for each wavelength band, different light transmission and light absorption characteristics.

Preferably, but not necessarily, the color wheel unit may include a second wavelength band light area unit formed to transmit the first wavelength band light and the second wavelength band light, a third wavelength band light area unit formed to transmit the first wavelength band light and the third wavelength band light, and a transmission area unit formed to transmit all the first wavelength band light, the second wavelength band light and the third wavelength band light.

Preferably, but not necessarily, the motor may be a single motor, and a length of the shaft and a discrete distance between the color wheel unit and the wavelength conversion wheel unit may be set in connection with a rotational driving force of the motor.

Preferably, but not necessarily, the projector may further comprise:

a first lens configured to focus the first wavelength band light irradiated from the light source module;

a first mirror so installed as to reflect at a right angle the first wavelength band light having transmitted the first lens;

a second lens configured to transmit the first wavelength band light reflected by the first mirror; and

a diffuser configured to diffuse the first wavelength band light having transmitted the second lens, and

a first optical system configured to generate a first light path from the light source module to the dichroic filter by including a diffuser configured to diffuse the first wavelength band light having transmitted the second lens.

Preferably, but not necessarily, the projector may further comprise:

a third lens configured to transmit the first wavelength band light reflected from the dichroic filter;

a second optical system configured to generate a second light path from the dichroic filter to the integrated wavelength conversion wheel and color wheel module by including a fourth lens positioned inside the integrated wavelength conversion wheel and the color wheel module to transmit the first wavelength band light having transmitted the third lens.

Preferably, but not necessarily, the projector may further comprise:

fifth and sixth lenses configured to transmit the first wavelength band light having transmitted the integrated wavelength conversion wheel and color wheel module;

a second mirror so installed as to reflect at a right angle the first wavelength band light having transmitted the sixth lens;

a third mirror so installed as to reflect at a right angle the first wavelength band light reflected by the second mirror; and

a third optical system configured to generate a third light path from the integrated wavelength conversion wheel and color wheel module to the dichroic filter by including a fourth mirror so installed as to reflect the first wavelength band light having transmitted the sixth lens at a right angle and to allow the reflected first wavelength band light to be incident on the dichroic filter.

Preferably, but not necessarily, the projector may further comprise a fourth optical system installed between the dichroic filter and an optical tunnel.

In another general aspect of the present disclosure, there is provided a projector, the projector comprising:

a light source module configured to generate a blue light;

a dichroic filter configured to transmit a green light and a red light by reflecting the blue light;

integrated wavelength conversion wheel and color wheel modules configured to integrally and parallel form a wavelength conversion wheel and a color wheel, where the color wheel transmits the blue light at all areas and selectively transmits the green light and the red light at a partial area, and the wavelength conversion wheel transmits the blue light or reflects the blue light by converting a wavelength of the blue light; and

an optical tunnel configured to receive the blue light reflected by the dichroic filter by transmitting the integrated wavelength conversion wheel and color wheel modules, and to receive the green light and the red light that transmit the dichroic filter after being reflected by being generated by the integrated wavelength conversion wheel and color wheel modules.

Preferably, but not necessarily, the integrated wavelength conversion wheel and color wheel may include a shaft interacted with a motor at one side, and a wavelength conversion wheel unit and a color wheel unit, each center of which is assembled on the shaft, discrete at a predetermined distance and integrally assembled on the shaft, wherein the color wheel unit is installed toward the dichroic filter, and the wavelength conversion wheel unit is discretely installed from the color wheel unit to a direction opposite to the dichroic filter.

Preferably, but not necessarily, the wavelength conversion wheel unit may include a first area interacted with the color wheel unit to transmit a part of the first wavelength band light incident by transmitting the color wheel unit, a second area configured to convert a wavelength of the blue light incident by transmitting the color wheel to a green light, and a third area configured to convert a wavelength of the blue light incident by transmitting the color wheel to a red light.

Preferably, but not necessarily, the color wheel unit may include a first area interacted with the wavelength conversion wheel unit to transmit the blue light incident from the dichroic filter to the wavelength conversion wheel unit, a second area configured to transmit the green light generated by the wavelength conversion wheel unit, and a third area configured to transmit the red light generated by the wavelength conversion wheel unit.

Preferably, but not necessarily, each of the wavelength conversion wheel unit and the color wheel unit may be formed of a disc shape having a predetermined diameter and driven at a same rotating speed by being formed around the shaft as a central axis.

Preferably, but not necessarily, the motor may be a single motor, and a length of the shaft and a discrete distance between the color wheel unit and the wavelength conversion wheel unit may be set in connection with a rotational driving force of the motor.

Preferably, but not necessarily, the projector may further comprise:

a first lens configured to focus the first wavelength band light irradiated from the light source module;

a first mirror so installed as to reflect at a right angle the first wavelength band light having transmitted the first lens;

a second lens configured to transmit the first wavelength band light reflected by the first mirror; and

a first optical system configured to generate a first light path from the light source module to the dichroic filter by including a diffuser configured to diffuse the first wavelength band light having transmitted the second lens.

Preferably, but not necessarily, the projector may further comprise:

a third lens configured to transmit the first wavelength band light reflected from the dichroic filter;

a second optical system configured to generate a second light path from the dichroic filter to the integrated wavelength conversion wheel and color wheel module by including a fourth lens positioned inside the integrated wavelength conversion wheel and the color wheel module to transmit the first wavelength band light having transmitted the third lens.

Preferably, but not necessarily, the projector may further comprise:

fifth lens and sixth lenses configured to transmit the first wavelength band light having transmitted the integrated wavelength conversion wheel and color wheel module;

a second mirror so installed as to reflect at a right angle the first wavelength band light having transmitted the sixth lens;

a third mirror so installed as to reflect at a right angle the first wavelength band light reflected by the second mirror; and

a third optical system configured to generate a third light path from the integrated wavelength conversion wheel and color wheel module to the dichroic filter by including a fourth mirror so installed as to reflect the first wavelength band light having transmitted the sixth lens at a right angle and to allow the reflected first wavelength band light to be incident on the dichroic filter.

Preferably, but not necessarily, the projector may further comprise a fourth optical system installed between the dichroic filter and an optical tunnel.

### ADVANTAGEOUS EFFECTS OF THE DISCLOSURE

The present disclosure has an advantageous effect in that a wave length wheel and a color wheel are integrally and parallel manufactured on one shaft each discrete from the other to allow driving the wave length wheel and the color wheel using a single motor whereby the number of parts and the manufacturing cost can be reduced.

### BRIEF DESCRIPTION OF DRAWINGS

FIG. 1 is a schematic diagram illustrating a projector with integrated wavelength conversion wheel and color wheel according to an exemplary embodiment of the present disclosure.

FIG. 2 is a conceptual view illustrating a wavelength conversion wheel unit in an integrated wavelength conversion wheel and color wheel module according to an exemplary embodiment of the present disclosure.

FIG. 3 is a conceptual view illustrating a color wheel unit in an integrated wavelength conversion wheel and color wheel module according to an exemplary embodiment of the present disclosure.

FIG. 4 is a schematic diagram illustrating a light path of blue light in a projector with an integrated wavelength conversion wheel and color wheel according to an exemplary embodiment of the present disclosure.

FIG. 5 is a schematic diagram illustrating a light path of green light in a projector with an integrated wavelength conversion wheel and color wheel according to an exemplary embodiment of the present disclosure.

FIG. 6 is a schematic diagram illustrating a light path of red light in a projector with an integrated wavelength conversion wheel and color wheel according to an exemplary embodiment of the present disclosure.

### DETAILED DESCRIPTION OF THE DISCLOSURE

Various aspects of the disclosure are described more fully hereinafter with reference to the accompanying drawings. This disclosure may, however, be embodied in many different forms and should not be construed as limited to any specific structure or function presented throughout this disclosure. It will be understood that the terms “comprises” and/or “comprising,”, “includes” and/or “including” when used in this specification, specify the presence of stated features, steps, operations, elements, and/or components, but do not preclude the presence or addition of one or more other features, steps, operations, elements, components, and/or groups thereof. Meantime, phosphor and fluorescent material may be interchangeably used herein.

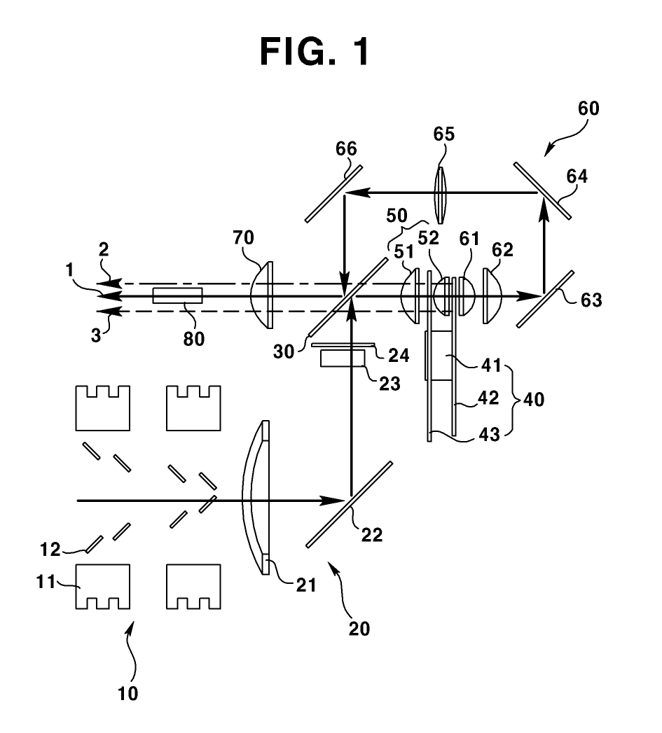

FIG. 1 is a schematic diagram illustrating a projector formed with integrated wavelength conversion wheel and color wheel according to an exemplary embodiment of the present disclosure.

Referring to FIG. 1, a projector with a wavelength conversion wheel and a color wheel in one module according to an exemplary embodiment of the present disclosure may include a light source module (10), a first optical system (20), a dichroic filter (30), an integrated wavelength conversion wheel and color wheel module (40), a second optical system (50), a third optical system (60), a fourth optical system (70) and a light tunnel (80). The wavelength conversion wheel may use the phosphor wheel. The light source module (10) may be formed with one or a plurality of semiconductor light sources (11) and a focusing mirror (12) to generate a blue light. The blue light generated by the light source (10) may be used as an excitation light for generating a red light and a green light through wavelength conversion.

Light wavelength of semiconductor light source may be generally in the range of 300 nm-800 nm. For example, the semiconductor light source may use a laser diode or a light emitting diode emitting a blue light. The semiconductor light source may also use a deep blue LD, a UV DL or a light emitting diode.

The first optical system (20) is an optical system configured to generate a first light path from the light source module (10) to the dichroic filter (30) in order to focus, reflect and guide the blue light generated by the light source module to the dichroic filter (30). The first optical system (20) may include a first lens (21), a first mirror (22), a second lens (23) and a diffuser (24).

The first lens (21) may be so installed as to transmit the blue light irradiated from the light source module (10) to the first mirror (22) by focusing the blue light. The first mirror (22) may be so installed as to reflect the blue light having transmitted the first lens (21) at a right angle. The second lens (23) may transmit the blue light reflected by the first mirror (22). The diffuser (24) may diffuse the blue light having transmitted the second lens (23). The dichroic filter (30) is a filter with a characteristic of reflecting the blue light irradiated from the light source module (10) and transmitting the red and green light.

The dichroic filter (30) is a material that reflects or transmits a light according to wavelength band, and may be so formed as to reflect a blue light having a shorter wavelength and to transmit a green light and a red light having a relatively longer wavelength. The dichroic filter (30) may reflect the blue light irradiated from the light source module (10) toward the integrated wavelength conversion wheel and color wheel module (40) in order to use as an excitation light for wavelength-conversion of red light or green light. The red light or green light irradiated from the integrated wavelength conversion wheel and color wheel module (40) is transmitted according to wavelength conversion of blue light as excitation light and transmitted to the light tunnel (80).

Furthermore, the dichroic filter (30) may reflect the blue light irradiated from the third optical system to the light tunnel (80).

The integrated wavelength conversion wheel and color wheel module (40) that a wavelength conversion wheel unit (42) and a color wheel unit (43) are integrally formed, where each central shaft of the wavelength conversion wheel unit (42) and the color wheel unit (43) is respectively assembled to a shaft (41) that receives a driving force from a motor. The shaft (41) is interlocked at one side with a motor, and is installed with the wavelength conversion wheel unit (42) and the color wheel unit (43) each spaced apart at a predetermined distance from the shaft (41) serving as a central axis.

The wavelength conversion wheel unit (42) may generate a red light and a green light by performing the wavelength conversion of red light and green light using the blue light as an excitation light relative to phosphor divisively formed on a surface of a wheel and reflect the red and green light to the color wheel unit (43). To this end, the wavelength conversion wheel unit (42) is coated at a surface thereof with phosphor, whereby red light and green light are respectively generated through the wavelength conversion of the phosphor coated on the surface of the wavelength conversion wheel unit (42). Meantime, the wavelength conversion wheel unit (42) can transmit the blue light according to areas of the wheel.

The wavelength conversion wheel unit (42) may include a wavelength conversion material configured to convert the wavelength of blue light to that of red (R) light and green (G) light. In general, the wavelength conversion wheel unit (42) takes a shape of a plate formed with a material that reflects light, and is rotated about the shaft (41) perpendicular to the plate shape and that penetrates a center of the plate shape. Hence, the blue light is incident on the rotating wavelength conversion wheel unit (42) from which the red (R) light and green (G) light are reflected.

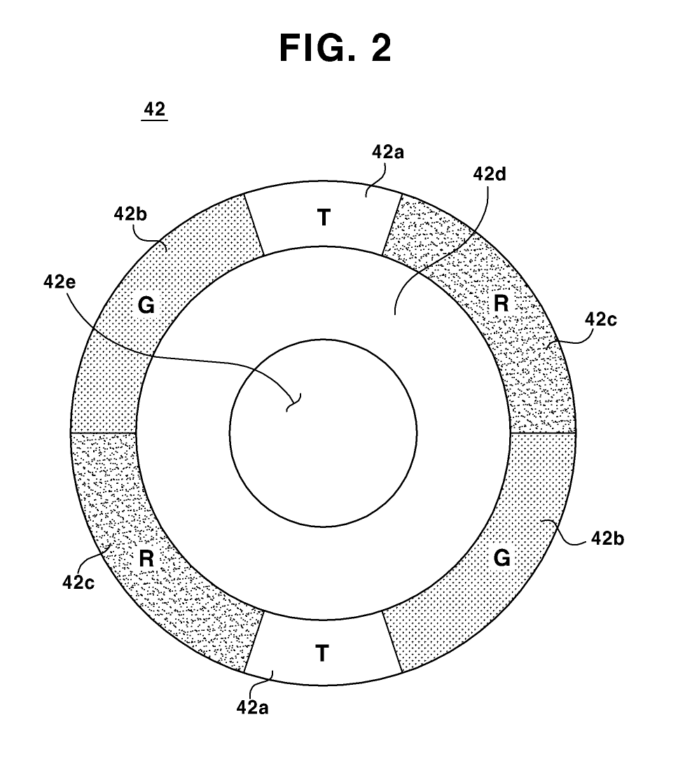

FIG. 2 is a conceptual view illustrating a wavelength conversion wheel unit in an integrated wavelength conversion wheel and color wheel module according to an exemplary embodiment of the present disclosure.

Referring to FIG. 2, the wavelength conversion wheel unit (42) may be formed by a plurality of segments, and may sequentially emit a plurality of wavelength band lights due to the rotation thereof. The wavelength conversion wheel unit (42) may be formed in the shape of a disc. The wavelength conversion wheel unit (42) may be formed with a transmission area (T. 42a) so as to transmit the blue light free from phosphor. The wavelength conversion wheel unit (42) may be also formed with a first wavelength conversion area (G, 42b) formed with the phosphor, where the wavelength conversion is realized to the green light through wavelength conversion using the blue light as excitation light. Furthermore, the wavelength conversion wheel unit (42) may be formed with a second wavelength conversion area (R, 42c) formed with the phosphor, where the wavelength conversion is realized to the red light through wavelength conversion using the blue light as excitation light.

The transmission area (T, 42a), the first wavelength conversion area (G, 42b) and the second wavelength conversion area (R, 42c) may be formed on a disc-shaped base (42d) of the wavelength conversion wheel unit (42) each with a predetermined width to a central direction from a circumference. However, the present disclosure is not limited thereto.

The disc-shaped base (42d) may be centrally formed with a hole (42e). The wavelength conversion wheel unit (42) may rotate about the shaft (41) coupled to the disc-shaped base (42d) through the hole (42e). The wavelength conversion wheel unit (42) may be formed in a shape of a metal disc.

Each divided size of the transmission area (T, 42a), the first wavelength conversion area (G, 42b) and the second wavelength conversion area (R, 42c) may be determined by color coordinate of phosphor that converts the size to respective wavelength band. That is, angle of the segment may be determined by a value of time reached by the blue light in response to the color coordinate and brightness of the phosphor.

It is preferable that the transmission area (T, 42a), the first wavelength conversion area (G, 42b) and the second wavelength conversion area (R, 42c) be sequentially arranged in order to allow various colors to be emitted as time flows.

While the wavelength conversion wheel unit (42) rotates, the blue light may be incident on one of the transmission area (T, 42a), the first wavelength conversion area (G, 42b) and the second wavelength conversion area (R, 42c). Furthermore, the incident blue light may be transmitted as it is, or wavelength-converted to red light.

However, each light having a plurality of colors may be mixed in response to the rotating speed of the wavelength conversion wheel unit (42) to be finally emitted as a white color through the light tunnel (80).

The first wavelength conversion area (G, 42b) of the wavelength conversion wheel unit (42) and the second wavelength conversion area (R, 42c) may be respectively coated with fluorescent material (phosphor). That is, the wavelength conversion wheel unit (42) may be formed at one side of the metal disc with a mirror layer. A powder-type fluorescent material mixed with binder such as silicon may be formed on the mirror layer to form a phosphor area. Other polymer than the silicon resin or glass powder may be also used.

The fluorescent materials coated on the surface of the first wavelength conversion area (G, 42b) for generating the green light may preferably include Y₃(Al,Ga)₅O₁₂:Ce, CaSc₂O₄:Ce, Ca₃(Sc,Mg)₂Si₃O₁₂:Ce, (Sr,Ba)₂SiO₄:Eu,(Si,Al)₆(O,N)₈:Eu (β sialon),(Ba,Sr)₃Si₆O₁₂N₂:Eu, SrGa₂S₄:Eu, BaMgAl₁₀O₁₇:Eu,Mn. More preferably, LuAG fluorescent material such as (Y_{1-x-y}LuxCey)₃Al₅O₁₂ may be also used.

The fluorescent materials coated on the surface of the second wavelength conversion area (R, 42c) for generating the red light may preferably include (Ca,Sr,Ba)₂Si₅(N,O)₈:Eu, (Ca, Sr,Ba)Si(N,O)₂:Eu, (Ca,Sr,Ba)AlSi(N,O)₈:Eu, (Sr,Ba)₃SiO₅:Eu, (Ca, Sr)S:Eu, (La,Y)₂O₂S:Eu, K₂SiF₆:Mn, CaAlSiN:Eu.

However, the present disclosure is not limited to the foregoing wavelength conversion materials and various other fluorescent materials may be used. Each wavelength band is reflected by the wavelength conversion materials.

Meantime, the fluorescent area may be formed in an optoceramic shape instead of mixed silicon resin. The optoceramic may be directly adhered on the mirror layer as a bulk type fluorescent film. An optoceramic material is a material mixed with inorganic or organic pigment that absorbs or transmits (or penetrates) a particular wavelength band of light where wavelength is changed by the fluorescent material.

The optoceramic is a ceramic material, and can be directly bonded to a wheel to make the manufacturing easy, and therefore heat stability can be relatively enhanced over silicon resin which is an organic matter.

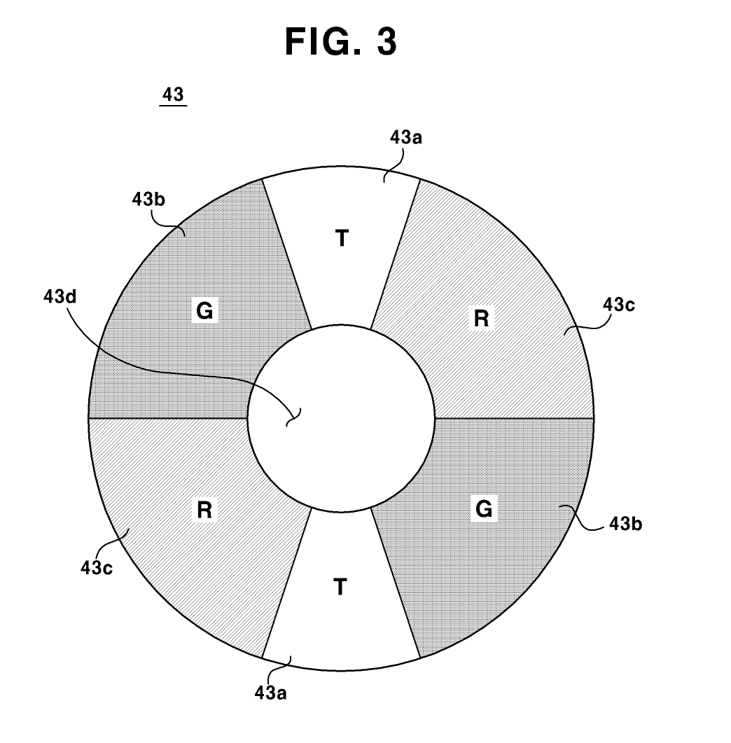

FIG. 3 is a conceptual view illustrating a color wheel unit in an integrated wavelength conversion wheel and color wheel module according to an exemplary embodiment of the present disclosure.

Referring to FIG. 3, the color wheel unit (43) may transmit the blue light incident from the dichroic filter (30) to the wavelength conversion wheel unit (42) in association with the wavelength conversion wheel unit (42). The color wheel unit (43) may be divided to a plurality of areas having mutually different light reflection, light transmission and light absorption characteristics for each color to allow the green light and the red light generated by wavelength conversion to the dichroic filter (30) using the blue light as excitation light. The color wheel unit (43) may include a transmission area part (T, 43a), a green light area part (G, 43b) and a red light area part (R, 43c) to correspond to the transmission area (T, 42a), the first wavelength conversion area (G, 42b) and the second wavelength conversion area (R, 42c) of the wavelength conversion wheel unit (42). The color wheel unit (43) may be formed at a center with a hole (43d) to be coupled to the shaft (41). The transmission area (T, 42a) may be formed to transmit all the blue color, the red color and the green color. The green light area part (G, 43b) may be formed to transmit the blue color and the green color. The red light area part (R, 43c) may be formed to transmit the blue color and the red color.

The color wheel unit (43) may perform the color division relative to the green light and the red light reflected on the wavelength conversion wheel unit (42) through the green light area part (G, 43b) and the red light area part (R, 43c).

Furthermore, the wavelength conversion wheel unit (42) and the color wheel unit (43) may be formed in the shape of a disc each having a predetermine diameter. The rotating speed of the wavelength conversion wheel unit (42) and that of the color wheel unit (43) are identically driven because both units (42, 43) are formed on the same shaft (41) as a central axis. As a result, a speckle phenomenon can be prevented that is generated when a light forms an image by the wavelength conversion wheel unit (42) and that of the color wheel unit (43).

The second optical system (50) may include a third lens (51) and a fourth lens (52) to generate a second light path from the dichroic filter (30) to the integrated wavelength conversion wheel and color wheel module (40). The third lens (51) may be so installed as to transmit the blue light reflected from the dichroic filter (30). The fourth lens (52) may be installed inside the integrated wavelength conversion wheel and color wheel module (40) to transmit the blue light having passed the third lens (51).

The third optical system (60) may include a fifth lens (61), a sixth lens (62), a second mirror (63), a third mirror (64), a seventh lens (65) and a fourth mirror (66) to form a third light path from the integrated wavelength conversion wheel and color wheel module (40) to the dichroic filter (30).

The fifth lens (61) and the sixth lens (62) may be so installed as to allow the blue light having passed the integrated wavelength conversion wheel and color wheel module (40) to transmit. The second mirror (63) may be so installed as to allow the blue light having transmitted the sixth lens (62) to reflect the blue light at a right angle. The third mirror (64) may be so installed as to allow the blue light reflected by the second mirror (63) to reflect the blue light at a right angle.

The seventh lens (65) may be so installed as to allow the blue light reflected by the third mirror (64) to transmit. The fourth mirror (66) may be so installed as to allow the blue light having transmitted the seventh lens (65) to reflect the blue light at a right angle and to be incident on the dichroic filter (30).

The fourth optical system (70) may focus the red light or the green light incident from the color wheel unit (43) by transmitting the dichroic filter (30) and the blue light incident by being reflected from the dichroic filter (30) through the third optical system and provide the red, green and blue lights to the light tunnel (80). The light tunnel (80) may irradiate the light incident from the fourth optical system (70) to outside.

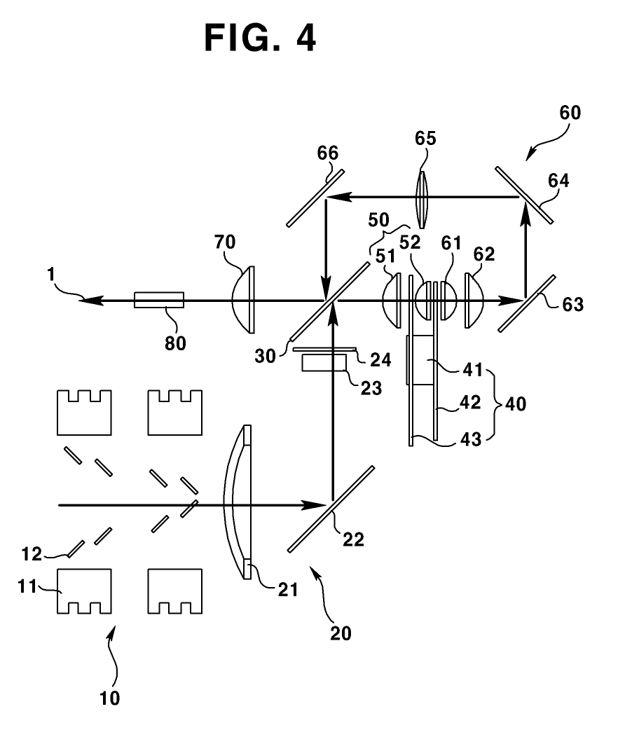

FIG. 4 is a schematic diagram illustrating a light path of blue light in a projector with an integrated wavelength conversion wheel and color wheel according to an exemplary embodiment of the present disclosure.

Referring to FIG. 4, the blue light may be irradiated from the light source module (10) to be outputted to outside through the first optical system (20), the dichroic filter (30), the second optical system (50), the integrated wavelength conversion wheel and color wheel module (40), the third optical system (60), the dichroic filter (30), the fourth optical system (70) and the light tunnel (80).

To be more specific, the blue light may be generated from one or a plurality of semiconductor light source (11) to be focused through the focusing lens (12) and to be irradiated from the light source module (10). The blue light irradiated from the light source module (10) may be transmitted to the first mirror (22) by being focused through the first lens (21). The blue light transmitted to the first mirror (22) may be reflected at a right angle by the first mirror (22). The blue light reflected by the first mirror (22) at a right angle may transmit the second lens (23) and may be diffused through the diffuser (24) to be incident on the dichroic filter (30).

The dichroic filter (30), which is a material configured to reflect the excitation light in response to wavelength, may reflect the short wavelength blue light and transmit the green light having a long wavelength, whereby the blue light incident on the dichroic filter (30) may be reflected to an integrated wavelength conversion wheel and color wheel module (40) side due to characteristics of the dichroic filter (30).

The blue light reflected by the dichroic filter (30) may be transmitted to the wavelength conversion wheel unit (42) by transmitting the third lens (51) and by being transmitted from all areas of the color wheel unit (43), i.e., the transmission area part (T, 43a), the green light area part (G, 43b) and the red light area part (R, 43c) and by transmitting the fourth lens (52). The blue light having transmitted the color wheel unit (43) and the fourth lens (52) is incident on the transmission area (T, 42a), the first wavelength conversion area (G, 42b) and the second wavelength conversion area (R, 42c). At this time, only the blue light incident on the transmission area (42a) of the wavelength conversion wheel unit (42) may transmit the wavelength conversion wheel unit (42) to be transmitted to the dichroic filter (30) through the third light path comprised of the fifth lens (61), the sixth lens (62), the second mirror (63), the third mirror (64), the seventh lens (65) and the fourth mirror (66).

To be more specific, the blue light having transmitted the transmission area (42a) of the wavelength conversion wheel unit (42) may be reflected at a right angle by the second mirror (63) by transmitting the fifth and sixth lenses (61, 62), and may be reflected in turn by the third mirror (64) at a right angle. The blue light reflected by the third mirror (64) at a right angle may transmit the seventh lens (65), may be reflected in turn at a right angle by the fourth mirror (66) and may be incident on the dichroic filter (30). The blue light incident on the dichroic filter (30) may be reflected by the dichroic filter (30) and provided to the light tunnel (80) by being focused through the fourth optical system (70).

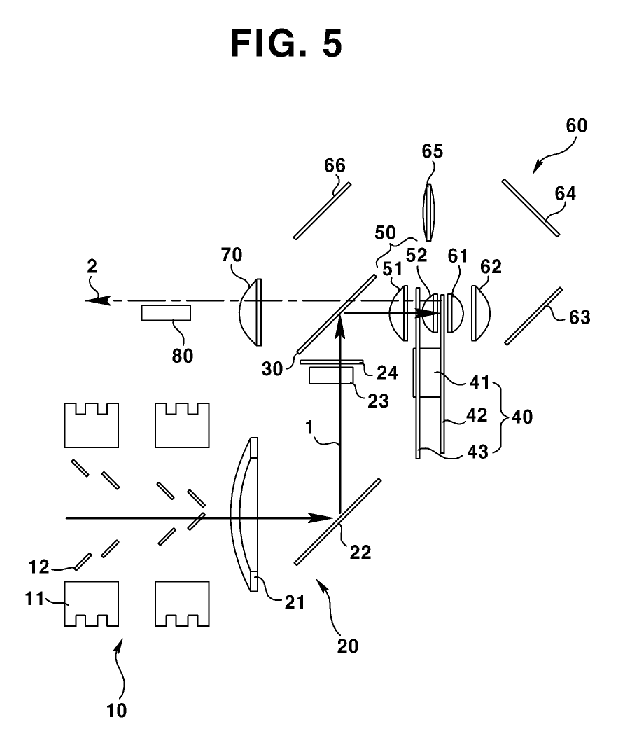

FIG. 5 is a schematic diagram illustrating a light path of green light in a projector with an integrated wavelength conversion wheel and color wheel according to an exemplary embodiment of the present disclosure.

Referring to FIG. 5, the blue light irradiated from the light source module (10) may be incident on the first optical system (20), the dichroic filter (30), the second optical system (50) and the integrated wavelength conversion wheel and color wheel module (40) to generate a green light according to the wavelength conversion at the integrated wavelength conversion wheel and color wheel module (40) and to be outputted to outside through the second optical system (50), the dichroic filter (30), the fourth optical system (70) and the light tunnel (80).

To be more specific, the blue light irradiated from the light source module (10) may be transmitted to the first mirror (22) by being focused through the first lens (21). The blue light transmitted to the first mirror (22) may be reflected at a right angle by the first mirror (22). The blue light reflected at a right angle by the first mirror (22) may transmit the second mirror (23) to be diffused through the diffuser (24) and to be incident on the dichroic filter (30).

The dichroic filter (30), which is a material configured to reflect the light in response to wavelength, may reflect the short wavelength blue light and transmit the green light and the red light having a relatively long wavelength, whereby the blue light incident on the dichroic filter (30) may be reflected to an integrated wavelength conversion wheel and color wheel module (40) side due to characteristics of the dichroic filter (30).

The blue light reflected by the dichroic filter (30) may transmit the third lens (51) and transmit all areas of the color wheel unit (43), i.e., the transmission area part (T, 43a), the green light area part (G, 43b) and the red light area part (R, 43c) and may be transmitted to the wavelength conversion wheel unit (42) by transmitting the fourth lens (52). The blue light having transmitted the color wheel unit (43) is incident on the transmission area (T, 42a), the first wavelength conversion area (G, 42b) and the second wavelength conversion area (R, 42c) of the wavelength conversion wheel unit (42). At this time, the green light is generated by the wavelength conversion to the wavelength band of the green light from the fluorescent material coated on the first wavelength conversion area by the blue light incident on the first wavelength conversion area (42b) of the wavelength conversion wheel unit (42).

The green light generated by the first wavelength conversion area (42b) of the wavelength conversion wheel unit (42) is reflected in turn to the color wheel unit (43) by transmitting the fourth lens (52). At this time, the color wheel unit (43) is integrally coupled to the wavelength conversion wheel unit (42) and the shaft (41) each at a predetermined distance, and the transmission area part (T, 43a), the green light area part (G, 43b) and the red light area part (R, 43c) are arranged to correspond to the transmission area (T, 42a), the first wavelength conversion area (G, 42b) and the second wavelength conversion area (R, 42c). Thus, the green light reflected by being generated from the first wavelength conversion area (42b) of the wavelength conversion wheel unit (42) may transmit the fourth lens (52) and be incident on the first wavelength conversion area (G, 42b) of the color wheel unit (43).

The green light area part (G, 43b) of the color wheel unit (43) is characterized of transmitting the blue light and the green light. Thus, the green light incident on the green light area part (G, 43b) of the color wheel unit (43) may transmit the green light area part (G, 43b) of the color wheel unit (43) and may be transmitted to the dichroic filter (30) by transmitting the third lens (51).

The dichroic filter (30), which is a material configured to reflect the light in response to wavelength, may reflect the short wavelength blue light and transmit the green light and the red light having a relatively long wavelength, whereby the green light incident on the dichroic filter (30) may transmit the dichroic filter (30) and be focused through the fourth optical system (70) and provided to the light tunnel (80).

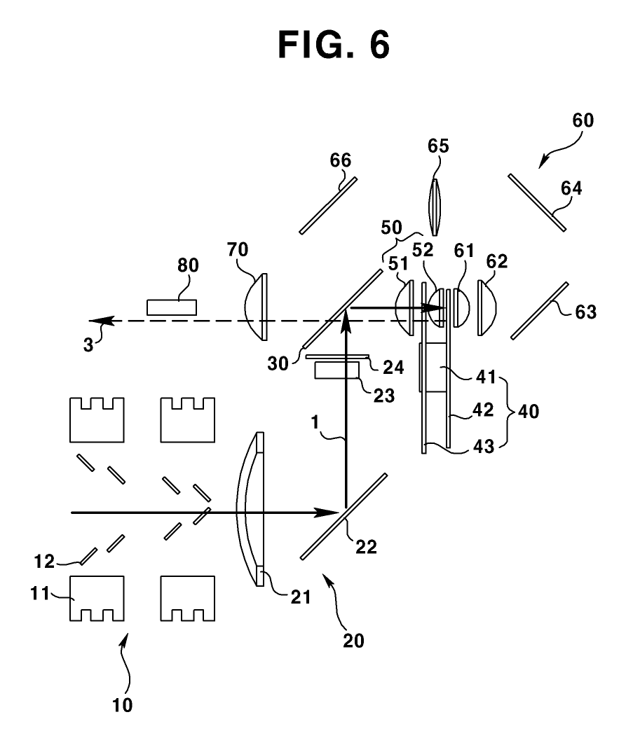

FIG. 6 is a schematic diagram illustrating a light path of red light in a projector with an integrated wavelength conversion wheel and color wheel according to an exemplary embodiment of the present disclosure. Referring to FIG. 6, the blue light irradiated from the light source module (10) may be incident on the first optical system (20), the dichroic filter (30), the second optical system (50) and the integrated wavelength conversion wheel and color wheel module (40) to generate a red light according to the wavelength conversion at the integrated wavelength conversion wheel and color wheel module (40) and to be outputted to outside through the second optical system (50), the dichroic filter (30), the fourth optical system (70) and the light tunnel (80).

To be more specific, the blue light irradiated from the light source module (10) may be transmitted to the first mirror (22) by being focused through the first lens (21). The blue light transmitted to the first mirror (22) may be reflected at a right angle by the first mirror (22). The blue light reflected at a right angle by the first mirror (22) may transmit the second mirror (23) to be diffused through the diffuser (24) and to be incident on the dichroic filter (30).

The dichroic filter (30), which is a material configured to reflect the light in response to wavelength, may reflect the short wavelength blue light and transmit the green light and the red light having a relatively long wavelength, whereby the blue light incident on the dichroic filter (30) may be reflected to an integrated wavelength conversion wheel and color wheel module (40) side due to characteristics of the dichroic filter (30).

The blue light reflected by the dichroic filter (30) may transmit the third lens (51) and transmit all areas of the color wheel unit (43), i.e., the transmission area part (T, 43a), the green light area part (G, 43b) and the red light area part (R, 43c) and may be transmitted to the wavelength conversion wheel unit (42) by transmitting the fourth lens (52). The blue light having transmitted the color wheel unit (43) is incident on the transmission area (T, 42a), the first wavelength conversion area (G, 42b) and the second wavelength conversion area (R, 42c) of the wavelength conversion wheel unit (42). At this time, the red light is generated by the wavelength conversion to the wavelength band of the red light from the fluorescent material coated on the second wavelength conversion area by the blue light incident on the second wavelength conversion area (42c) of the wavelength conversion wheel unit (42).

The red light generated by the second wavelength conversion area (42c) of the wavelength conversion wheel unit (42) may be reflected in turn to the color wheel unit (43) by transmitting the fourth lens (52).

At this time, the color wheel unit (43) is integrally coupled to the wavelength conversion wheel unit (42) and the shaft (41) each at a predetermined distance, and the transmission area part (T, 43a), the green light area part (G, 43b) and the red light area part (R, 43c) are arranged to correspond to the transmission area (T, 42a), the first wavelength conversion area (G, 42b) and the second wavelength conversion area (R, 42c) of the wavelength conversion wheel unit (42). Thus, the green light reflected by being generated from the first wavelength conversion area (42b) of the wavelength conversion wheel unit (42) may transmit the fourth lens (52) and be incident on the red light area part (R, 43c) of the color wheel unit (43).

The red light area part (R, 43c) of the color wheel unit (43) is characterized of transmitting the blue light and the red light. Thus, the red light incident on the red light area part (R, 43c) of the color wheel unit (43) may transmit the red light area part (R, 43c) of the color wheel unit (43) and transmitted to the dichroic filter (30) by transmitting the third lens (51).

The dichroic filter (30), which is a material configured to reflect the light in response to wavelength, may reflect the short wavelength blue light and transmit the green light and the red light having a relatively long wavelength, whereby the red light incident on the dichroic filter (30) may be focused through the fourth lens (70) by transmitting the dichroic filter (30) and provided to the light tunnel (80).

Although the present disclosure has been described in detail with reference to the foregoing embodiments and advantages, many alternatives, modifications, and variations will be apparent to those skilled in the art within the metes and bounds of the claims. Therefore, it should be understood that the above-described embodiments are not limited by any of the details of the foregoing description, unless otherwise specified, but rather should be construed broadly within the scope as defined in the appended claims.

What is claimed is:

1. A projector with a phosphor wheel and a color wheel in one module; the projector comprising:
a light source configured to generate a first wavelength band light;
a dichroic filter configured to reflect the first wavelength band light irradiated from the light source, and to transmit a second wavelength band light and a third wavelength band light;
an integrated wavelength conversion wheel and color wheel module configured to integrally form a wave length wheel and a color wheel each wheel in a parallel manner in order to allow transmitting the first wavelength band light reflected from the dichroic filter and to generate the second wavelength band light and the third wavelength band light through wavelength conversion using the first wavelength band light as an excited light and to reflect the generated second wavelength band light and the third wavelength band light to the dichroic filter; and a light tunnel configured to receive the first wavelength band light reflected from the dichroic filter by transmitting the integrally formed wave length wheel and color wheel, and the second wavelength band light and the third wavelength band light transmit through the dichroic filter by being generated by and reflected from the integrally formed wave length wheel and color wheel.

2. The projector of claim 1, wherein the integrated wavelength conversion wheel and color wheel module includes a shaft interacted with a motor at one side, and a wavelength conversion wheel unit and a color wheel unit, each center of which is assembled on the shaft, discrete at a predetermined distance and integrally assembled on the shaft, wherein the color wheel unit is installed toward the dichroic filter, and the wavelength conversion wheel unit is discretely installed from the color wheel unit to a direction opposite to the dichroic filter.

3. The projector of claim 2, wherein the wavelength conversion wheel unit includes a first area interacted with the color wheel unit to transmit a part of the first wavelength band light incident by transmitting the color wheel unit, and second and third areas respectively configured to generate the second wavelength band light and the third wavelength band light through wavelength conversion of phosphor using, as an excitation, another part of the wavelength band light incident by transmitting the color wheel unit, wherein each of the second and third areas is divided to a plurality of areas, each having a different wavelength conversion characteristic for each wavelength band, different light reflection and different light transmission characteristics.

4. The projector of claim 2, wherein the color wheel unit includes a first area interacted with the wavelength conversion wheel unit to transmit a part of the first wavelength band light incident from the dichroic filter to the wavelength conversion wheel unit, and second and third areas selectively transmitting the second wavelength band light and the third wavelength band light generated by the wavelength conversion wheel unit toward a dichroic filter side, wherein each of the second and third areas is divided to a plurality of areas, each having a different light reflection characteristic for each wavelength band, different light transmission and light absorption characteristics.

5. The projector of claim 4, wherein the color wheel unit includes a second wavelength band light area unit formed to transmit the first wavelength band light and the second wavelength band light, a third wavelength band light area unit formed to transmit the first wavelength band light and the third wavelength band light, and
a transmission area unit formed to transmit all the first wavelength band light, the second wavelength band light and the third wavelength band light.

6. The projector of claim 2, wherein the motor is a single motor, and a length of the shaft and a discrete distance between the color wheel unit and the wavelength conversion wheel unit is set in connection with a rotational driving force of the motor.

7. The projector of claim 1, further comprising:
a first lens configured to focus the first wavelength band light irradiated from the light source module;
a first mirror so installed as to reflect at a right angle the first wavelength band light having transmitted the first lens;
a second lens configured to transmit the first wavelength band light reflected by the first mirror; and
a diffuser configured to diffuse the first wavelength band light having transmitted the second lens, and a first optical system configured to generate a first light path from the light source module to the dichroic filter by including a diffuser configured to diffuse the first wavelength band light having transmitted the second lens.

8. The projector of claim 1, further comprising:
a third lens configured to transmit the first wavelength band light reflected from the dichroic filter;
a second optical system configured to generate a second light path from the dichroic filter to the integrated wavelength conversion wheel and color wheel module by including a fourth lens positioned inside the integrated wavelength conversion wheel and the color wheel module to transmit the first wavelength band light having transmitted the third lens.

9. The projector of claim 1, further comprising:
fifth and sixth lenses configured to transmit the first wavelength band light having transmitted the integrated wavelength conversion wheel and color wheel module;
a second mirror so installed as to reflect at a right angle the first wavelength band light having transmitted the sixth lens;
a third mirror so installed as to reflect at a right angle the first wavelength band light reflected by the second mirror; and
a third optical system configured to generate a third light path from the integrated wavelength conversion wheel and color wheel module to the dichroic filter by including a fourth mirror so installed as to reflect the first wavelength band light having transmitted the sixth lens at a right angle and to allow the reflected first wavelength band light to be incident on the dichroic filter.

10. The projector of claim 1, further comprising a fourth optical system installed between the dichroic filter and an optical tunnel.

11. A projector, the projector comprising:
a light source module configured to generate a blue light;
a dichroic filter configured to transmit a green light and a red light by reflecting the blue light;
integrated wavelength conversion wheel and color wheel modules configured to integrally and parallel form a wavelength conversion wheel and a color wheel, where the color wheel transmits the blue light at all areas and selectively transmits the green light and the red light at a partial area, and the wavelength conversion wheel transmits the blue light or reflects the blue light by converting a wavelength of the blue light; and
an optical tunnel configured to receive the blue light reflected by the dichroic filter by transmitting the integrated wavelength conversion wheel and color wheel modules, and to receive the green light and the red light that transmit the dichroic filter after being reflected by being generated by the integrated wavelength conversion wheel and color wheel modules.

12. The projector of claim 11, wherein the integrated wavelength conversion wheel and color wheel includes a shaft interacted with a motor at one side, and a wavelength conversion wheel unit and a color wheel unit, each center of which is assembled on the shaft, discrete at a predetermined distance and integrally assembled on the shaft, wherein the color wheel unit is installed toward the dichroic filter, and the wavelength conversion wheel unit is discretely installed from the color wheel unit to a direction opposite to the dichroic filter.

13. The projector of claim 12, wherein the wavelength conversion wheel unit includes a first area interacted with the color wheel unit to transmit a part of the first wavelength band light incident by transmitting the color wheel unit, a second area configured to convert a wavelength of the blue light incident by transmitting the color wheel to a green light, and a third area configured to convert a wavelength of the blue light incident by transmitting the color wheel to a red light.

14. The projector of claim 12, wherein the color wheel unit includes a first area interacted with the wavelength conversion wheel unit to transmit the blue light incident from the dichroic filter to the wavelength conversion wheel unit, a second area configured to transmit the green light generated by the wavelength conversion wheel unit, and a third area configured to transmit the red light generated by the wavelength conversion wheel unit.

15. The projector of claim 12, wherein each of the wavelength conversion wheel unit and the color wheel unit is formed of a disc shape having a predetermined diameter and driven at a same rotating speed by being formed around the shaft as a central axis.

16. The projector of claim 12, wherein the motor is a single motor, and a length of the shaft and a discrete distance between the color wheel unit and the wavelength conversion wheel unit is set in connection with a rotational driving force of the motor.

17. The projector of claim 11, further comprising:
a first lens configured to focus the first wavelength band light irradiated from the light source module;
a first mirror so installed as to reflect at a right angle the first wavelength band light having transmitted the first lens;
a second lens configured to transmit the first wavelength band light reflected by the first mirror; and
a first optical system configured to generate a first light path from the light source module to the dichroic filter by including a diffuser configured to diffuse the first wavelength band light having transmitted the second lens.

18. The projector of claim 11, further comprising:
a third lens configured to transmit the first wavelength band light reflected from the dichroic filter;
a second optical system configured to generate a second light path from the dichroic filter to the integrated wavelength conversion wheel and color wheel module by including a fourth lens positioned inside the integrated wavelength conversion wheel and the color wheel module to transmit the first wavelength band light having transmitted the third lens.

19. The projector of claim 11, further comprising:
fifth lens and sixth lenses configured to transmit the first wavelength band light having transmitted the integrated wavelength conversion wheel and color wheel module;
a second mirror so installed as to reflect at a right angle the first wavelength band light having transmitted the sixth lens;
a third mirror so installed as to reflect at a right angle the first wavelength band light reflected by the second mirror; and
a third optical system configured to generate a third light path from the integrated wavelength conversion wheel and color wheel module to the dichroic filter by including a fourth mirror so installed as to reflect the first wavelength band light having transmitted the sixth lens at a right angle and to allow the reflected first wavelength band light to be incident on the dichroic filter.

20. The projector of claim 11, further comprising a fourth optical system installed between the dichroic filter and an optical tunnel.
